(19) United States
(12) Patent Application Publication
(10) Pub. No.: US 2007/0095229 A1
(43) Pub. Date: May 3, 2007

(54) Apparatus and method for registering a position of a component of a press

(75) Inventors: Alfons Baintner, Aystetten (DE); Nils-Hendric Schall, Augsburg (DE); Klaus Liepert, Westendorf (DE); Juergen Ziegler, Gersthofen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/517,047

(22) Filed: Sep. 7, 2006

(30) Foreign Application Priority Data
Sep. 9, 2005 (DE) 10 2005 042.932.7

(51) Int. Cl. B41F 13/24

(52) U.S. Cl. 101/248

(57) ABSTRACT

An apparatus and method for registering a position of a component of a press is disclosed. The press having a plurality of components that can rotate about a central longitudinal axis, such as a main drive shaft and press cylinders, at least one of these components being assigned at least one position registering device, which registers the angular position of the respective component. The, or each, position registering device is formed as a magnetic rotary encoder.

This application claims the priority of German Patent Document No. 10 2005 042 932.7, filed Sep. 9, 2005, the disclosure of which is expressly incorporated by reference herein.

### BACKGROUND AND SUMMARY OF THE INVENTION

The invention relates to a press, in particular a web-fed press.

Optical rotary encoders are normally used on presses in order to register the position of components that are driven rotationally or in rotation. Optical rotary encoders of this type have their own mechanical drive shaft and an independent mounting, which results in the disadvantage that the mechanical drive shaft of the rotary encoder has to be connected mechanically via complicated measures to a drive shaft of a component which is to be monitored with respect to its position. This mechanical connection between the drive shaft of the component driven rotationally or in rotation and the drive shaft of the optical rotary encoder is in this case carried out at an axial end position of the drive shaft of the component driven rotationally or in rotation and therefore at an axial position which is usually subjected to high torsional stresses. This can result in a reduction in the quality of the position detection. Further disadvantages of optical rotary encoders reside in the fact that the bearings of the same are subject to wear, and that optical encoders are highly sensitive to contamination. Therefore, according to the prior art, complicated encapsulation measures are required in order to protect the optical rotary encoder against contamination. In any case, however, complicated maintenance work is required on optical rotary encoders in order to clean the same from time to time.

Taking this as a starting point, the present invention is based on the problem of providing a novel type of press, in particular a novel type of web-fed press.

According to the invention, the, or each, position registering device is formed as a magnetic rotary encoder.

In the spirit of the present invention, it is proposed to use magnetic rotary encoders as position registering devices on rotatable components of a press. In this case, use is made of magnetic absolute value rotary encoders which do not have their own bearings. Such magnetic rotary encoders which do not have their own bearings are subjected to virtually no mechanical wear and therefore have a virtually unlimited mechanical lifetime. The magnetic rotary encoders are insensitive with respect to contamination. The position registration is carried out by means of the interplay of an index ring and a sensing head of the magnetic rotary encoder, the index ring being assigned to the rotating component and the sensing head being assigned to a stationary bearing element of the rotating component. The position registration with magnetic rotary encoders of this type is carried out without contact via an air gap between the index ring and the sensing head of the magnitude rotary encoder. The index ring can be arranged at virtually any axial position of the drive shaft of the rotating component, preferably at an axial position which is subjected to low torsional stress. A highly accurate measurement is possible in this way.

### BRIEF DESCRIPTION OF THE DRAWINGS

Preferred developments of the invention emerge from the following description. Exemplary embodiments of the invention, without being restricted thereto, will be explained in more detail by using the drawings, in which:

FIG. 1 shows a detail from a press according to the invention in the region of a rotatable component;

FIG. 2 shows a cross section through the arrangement of FIG. 1 along the section direction II-II according to FIG. 1; and

FIG. 3 shows a cross section through an alternative configuration of the invention in an illustration analogous to FIG. 2.

### DETAILED DESCRIPTION OF THE DRAWINGS

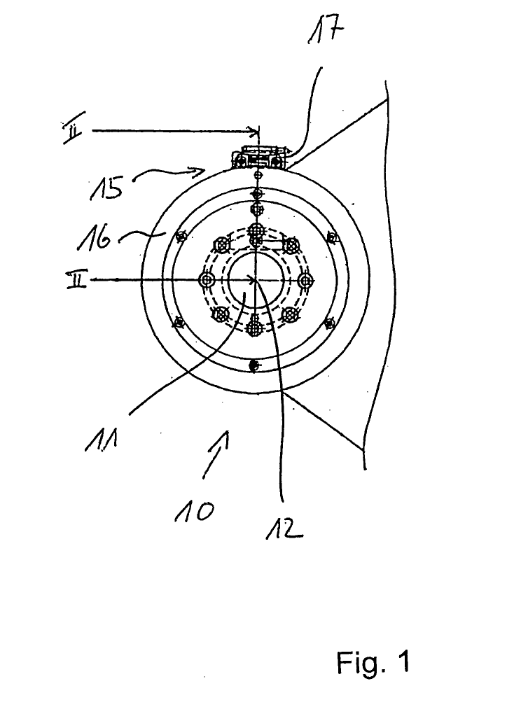

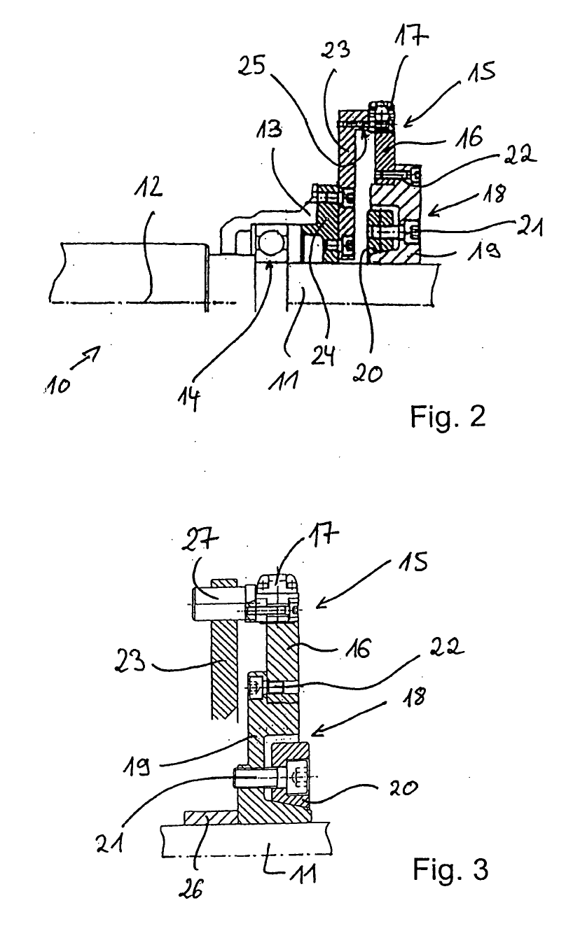

FIGS. 1 and 2 show a detail from a press according to the invention in the region of a component driven in rotation or rotationally and constructed as a press cylinder 10. The press cylinder 10 has a drive shaft 11 and can be driven in rotation about a central longitudinal axis 12 via the drive shaft 11. The drive shaft 11 is mounted on a stationary bearing element 13. FIG. 2 shows a rotary bearing 14 for mounting the press cylinder 10 and the drive shaft 11 of the same on a stationary bearing element 13.

In order to register the position of the press cylinder 10, specifically in order to register its angular position, the press cylinder 10 is assigned at least one position registering device 15, in the spirit of the present invention the, or each, position registering device 15 being formed as a magnetic rotary encoder. The press cylinder 10 is preferably assigned two position registering devices 15 formed as magnetic rotary encoders, in order in this way to provide a possible redundant measurement and to increase the security against failure of the position registration of the press cylinder 10.

The, or each, magnetic rotary encoder is preferably formed as a magnetic absolute value rotary encoder without its own bearings. Such magnetic rotary encoders without their bearings have an index ring 16 and a sensing head 17. The index ring 16 is designed as a separate subassembly in the exemplary embodiment of FIGS. 1 and 2 and is fixed to the drive shaft 11 of the press cylinder 10.

As can be gathered in particular from FIG. 2, the index ring 16 is connected via a clamping ring connection 18 to the drive shaft 11 of the press cylinder 10 or coupled firmly to the shaft so as to rotate with it, so that the index ring 16, together with the press cylinder 10 and the drive shaft 11 of the same, rotates about the central longitudinal axis 12. The clamping ring connection 18 comprises two clamping ring elements 19 and 20, a first clamping ring element 19 being seated on the drive shaft 11 and holding a second clamping ring element 20; as a result of screws 21 being tightened, the second clamping ring element 20 pressing the first clamping ring element 19 against the drive shaft 11 and thus fixing the latter firmly to the drive shaft 11 so as to rotate with it. The index ring 16 is connected to the first clamping ring element 19 via screws 22.

The sensing head 17 of the position registering device 15, preferably formed as a magnetic absolute value rotary encoder, is assigned to the stationary bearing element 13 and fixed in its location on the stationary bearing element 13. For this purpose, the sensing head 17 is arranged on a carrier element 23 and, via the carrier element 23, is screwed to an attachment section 24 of the stationary bearing element 13. Here, the sensing head 17 is screwed to the stationary bearing element 13 or the carrier element 23 in such a way that a high degree of stiffness in the circumferential direction or direction of rotation is ensured, in order in this way to minimize oscillations of the sensing head 17 in the circumferential direction or direction of rotation of the press cylinder 10. This is achieved by a section 25 of the carrier element 23 which extends in the axial direction and to which the sensing head 17 has been screwed having a relatively short extent in the axial direction. This results in a stiff attachment in the circumferential direction of the sensing head 17 to the carrier element 23 of the stationary bearing element 13.

In the exemplary embodiment illustrated in FIGS. 1 and 2, the index ring 16 of the magnetic rotary encoder 15 is accordingly connected to the drive shaft 11 of the press cylinder 10 and rotates with the same. On the other hand, the sensing head 17 is screwed to the stationary bearing element 13.

Between the index ring 16 and the sensing head 17 of the magnetic rotary encoder, an air gap of the order of magnitude of a few tenths of a millimeter is formed. The sensing and therefore the registration of the position is carried out without contact via this gap.

The index ring 16 of the position registering device 15, designed as a separate subassembly in the exemplary embodiment of FIGS. 1 and 2, can be arranged via the clamping ring connection 18 at virtually any desired axial position of the drive shaft 11 or of the component driven in rotation. In this case, the index ring 16 is preferably firmly connected to the drive shaft 11 so as to rotate with it at an axial position which is subjected to little torsional stress. In this way, a high quality of the measured result can be ensured.

In the exemplary embodiment of FIGS. 1 and 2, the axial position of the sensing head 17 is predefined by the stationary bearing element 13. In order to adjust the position registering device 15, the axial position of the index ring 16 on the drive shaft 11 relative to the sensing head 17 can be adjusted. For this purpose, it is merely necessary for the clamping ring element 19 to be displaced relative to the drive shaft 11 and also relative to the stationary sensing head 17 with the clamping ring connection 18 released, in order then, following adjustment, to be fixed firmly to the drive shaft 11 so as to rotate with it in the respective axial position, by the screws 21 being tightened.

Alternatively, it is also possible to predefine the axial position of the index ring 16 on the drive shaft 11 and to displace the sensing head 17 relative to the index ring 16 in order to adjust the position registering device 15. Thus, FIG. 3 shows an exemplary embodiment of the invention in which the axial position of the index ring 16 on the drive shaft 11 is predefined via a stop 26 assigned to the drive shaft 11. In order to adjust the position registering device 15, the sensing head 17 then has to be aligned relative to the index ring 16, for this purpose the sensing head 17 being guided via a guide element 27 such that it can be displaced in the axial direction in the carrier element 23.

At this point, it should be pointed out that the index ring 16 has an internal diameter which is matched to the external diameter of the drive shaft 11 or the press cylinder 10.

The measured signal provided by the position registering devices 15 can be used for the purpose -of implementing drive control for the press cylinder 10 to which the position registering device 15 is assigned. Alternatively or in combination with this, it is also possible to use the measured signal from the position registering device 15 which is assigned to the press cylinder 10 for the drive control of another component driven in rotation or rotationally. In this case, the measured signal from the position registering device 15 represents a master signal for another component of the press.

In the exemplary embodiments shown by FIGS. 1 to 3, it was assumed that the position registering device is assigned to a press cylinder driven in rotation. It should be pointed out that the invention can also be used on other components of a press that are driven in rotation, for example on a main drive shaft of a press, which is also designated the master shaft. In this case, with the aid of a magnetic rotary encoder, the angular position of the main drive shaft is monitored by means of measurement, it being possible for drive control for the main drive shaft and/or a drive shaft for other units of the presses, for example a folder, to be implemented on the basis of the measured signal provided.

In the exemplary embodiments shown, the index ring 16 of the magnetic rotary encoder is in each case designed as a separate subassembly. In a departure from this, it is also possible for the index ring 16 to be an integral constituent part of the drive shaft 11, accordingly for the drive shaft 11 to bear an appropriate magnetic index directly.

With the present invention, a position measurement or angular position measurement of rotating components of a press is made possible, which measurement does not have its own bearings and is insensitive to contamination. Use is preferably made of magnetic absolute value rotary encoders without their own bearings, which register the angular position of the rotating components at every time. As a result of the virtually unlimited mechanical lifetime of such position registering devices, only little expenditure on maintenance for the same is required.

### LIST OF REFERENCE SYMBOLS

10 Press cylinder

11 Drive shaft

12 Central longitudinal axis

13 Bearing element

14 Rotary bearing

15 Position registering device

16 Index ring

17 Sensing head

18 Clamping ring connection

19 Clamping ring element

20 Clamping ring element

21 Screw

22 Screw

23 Carrier element

24 Attachment section

25 Section

26 Stop

27 Guide element

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A press, in particular a web-fed press, having a plurality of components that are rotatable about a central longitudinal axis, such as a main drive shaft and press cylinders, at least one of these components being assigned at least one position registering device which registers an angular position of the respective component, wherein the position registering device is formed as a magnetic rotary encoder.

2. The press according to claim 1, wherein the position registering device is formed as a rotary encoder without a bearing.

3. The press according to claim 1, wherein the position registering device is formed as an absolute value rotary encoder.

4. The press according to claim 1, wherein the magnetic rotary encoder has an index ring and a sensing head, wherein the index ring is assigned to a drive shaft of the respective component and rotates with the respective component, and wherein the sensing head is assigned to a stationary bearing element of the respective component.

5. The press according to claim 4, wherein the index ring is formed as a separate subassembly and is fixed to the drive shaft of the respective component.

6. The press according to claim 4, wherein the index ring has an internal diameter which is matched to an external diameter of the drive shaft of the respective component.

7. The press according to claim 4, wherein the index ring is fixed to the drive shaft via a clamp connection.

8. The press according to claim 4, wherein the index ring is arranged at an axial position of the drive shaft at which there is little torsional stressing of the drive shaft.

9. The press according to claim 4, wherein a position of the sensing head on the stationary bearing element of the respective component is fixed, and wherein a position of the index ring on the drive shaft relative to the sensing head is adjustable to adjust the position registering device.

10. The press according to claim 4, wherein an axial position of the index ring on the drive shaft is fixed, and wherein a position of the sensing head relative to the index ring is adjustable to adjust the position registering device.

11. The press according to claim 4, wherein the index ring is integrally formed with the drive shaft of the respective component.

12. The press according to claim 4, wherein the sensing head is fixed on the stationary bearing element of the respective component with a stiffness that is high in a circumferential direction or a direction of rotation such that oscillations of the sensing head are minimized in the circumferential direction or the direction of rotation.

13. The press according to claim 1, wherein a measured signal which is registered by the position registering device is used for a drive control of the respective component.

14. The press according to claim 1, wherein a measured signal which is registered by the position registering device is used for a drive control of another one of the plurality of components.

15. A press, comprising:
a rotatable component; and
a position registering device, wherein the position registering device registers an angular position of the component, and wherein the position registering device is a magnetic rotary encoder.

16. The press according to claim 15, wherein the position registering device includes an index ring and a sensing head, wherein the index ring is disposed on the component and wherein the sensing head is disposed on a stationary bearing element of the component.

17. The press according to claim 16, wherein an air gap is defined between the index ring and the sensing head and wherein the position registering device registers the angular position of the component across the air gap.

18. A method for registering a position of a component of a press, comprising the steps of:
disposing an index ring of a position registering device on a rotatable component;
disposing a sensing head of the position registering device on a stationary bearing element of the component; and
registering an angular position of the component across an air gap defined by the index ring and the sensing head by the position registering device.

19. The method according to claim 18, wherein the index ring is disposed at an axially intermediate position on the rotatable component.

20. The method according to claim 18, wherein the position registering device is a magnetic rotary encoder.
